(19) United States
(12) Patent Application Publication
(10) Pub. No.: US 2024/0242060 A1
(43) Pub. Date: Jul. 18, 2024

(54) METHOD AND ELECTRONIC DEVICE FOR PROVIDING A NEURAL ARCHITECTURE SEARCH

(71) Applicant: SAMSUNG ELECTRONICS CO.,LTD., Suwon-si (KR)

(72) Inventors: Srinivas Soumitri MIRIYALA, Visakhapatnam (IN); Ashutosh Pavagada VISWESWARA, Bangalore (IN); Suhas P K, Bangalore (IN); Vikram Nelvoy RAJENDIRAN, Bangalore (IN)

(73) Assignee: SAMSUNG ELECTRONICS CO.,LTD., Suwon-si (KR)

(21) Appl. No.: 18/415,261

(22) Filed: Jan. 17, 2024

Related U.S. Application Data
(63) Continuation of application No. PCT/KR23/21715, filed on Dec. 27, 2023.

(30) Foreign Application Priority Data
Jan. 18, 2023 (IN) 202341003625
Oct. 30, 2023 (IN) 202341003625

(51) Int. Cl. G06N 3/04

(52) U.S. Cl. CPC G06N 3/04

(57) ABSTRACT

According to an embodiment of the disclosure, a method may include providing, by the electronic device, a plurality of Pareto fronts based on at least two performance parameters. The method may include identifying, by the electronic device, an optimal Pareto front from among the plurality of Pareto fronts. The method may include providing, by the electronic device, a second AI model iteratively. The method may include identifying, by the electronic device, whether the second AI model belongs to the optimal Pareto front. The method may include identifying, by the electronic device, the at least two performance parameters corresponding to the second AI model based on identifying that the second AI model belongs to the optimal Pareto front. The method may include obtaining, by the electronic device, the second AI model based on identifying that the second AI model meets one or more predetermined performance parameters.

### CROSS-REFERENCE TO RELATED APPLICATIONS

This application is a continuation of International Application No. PCT/KR2023/021715, filed on Dec. 27, 2023, in the Korean Intellectual Property Receiving Office, which is based on and claims priority to Indian Provisional Application Number 202341003625 filed on Jan. 18, 2023, and Indian Patent Application No. 202341003625 filed on Oct. 30, 2023, in the Indian Patent Office, the disclosures of which are incorporated by reference herein in their entireties.

### BACKGROUND

### 1. Field

The present disclosure relates to neural architecture search, and more specifically neural architecture search using Pareto fronts.

### 2. Description of Related Art

General Neural Architecture Search (NAS) is a sophisticated methodology which may be employed to explore the most optimal designs for Deep Neural Networks (DNNs) to ensure peak network performance. The expansive array of DNN designs encompasses the number of layers and channels, types of activations, as well as the type of connections employed. The amalgamation of these designs results in numerous DNN candidates. However, navigating through multiple candidates to identify the most desirable design or designs is a challenging and intricate task. This search may be governed by objectives to be met by the desired candidate, and the pursuit of these objectives amidst a sea of candidates drastically increases the time and complexity involved.

Some techniques employed for optimal design of the DNN involve a sequential approach towards one or more objectives, which may entail a substantial amount of time for searching among the various candidates. Additionally, the selection of the desired candidate may necessitate multiple iterations, thereby contributing to an increased computational cost.

Thus, there is a need for a mechanism for fast and accurate design of the DNN that is devoid of the above issues.

### SUMMARY

According to an embodiment of the disclosure, a method may include providing, by the electronic device, a plurality of Pareto fronts based on at least two performance parameters. The method may include identifying, by the electronic device, an optimal Pareto front from among the plurality of Pareto fronts. The method may include providing, by the electronic device, a second AI model iteratively. The method may include identifying, by the electronic device, whether the second AI model belongs to the optimal Pareto front. The method may include identifying, by the electronic device, the at least two performance parameters corresponding to the second AI model based on the identifying whether the second AI model belongs to the optimal Pareto front. The method may include obtaining, by the electronic device, the second AI model based on identifying that the second AI model meets one or more predetermined performance parameters.

According to an embodiment of the disclosure, an electronic device comprising a memory, a communicator coupled to the memory and at least one processor coupled to the memory and the communicator is provided. The at least one processor may be configured to provide a plurality of Pareto fronts based on at least two performance parameters. The at least one processor may be configured to identify an optimal Pareto front from among the plurality of Pareto fronts. The at least one processor may be configured to provide a second AI model iteratively. The at least one processor may be configured to identify whether the second AI model belongs to the optimal Pareto front. The at least one processor may be configured to identify the at least two performance parameters with respect to the second AI model based on identifying that the second AI model belongs to the optimal Pareto front. The at least one processor may be configured to obtain the second AI model based on identifying that the second AI model meets one or more predetermined performance parameters.

According to an embodiment of the disclosure, a non-transitory computer-readable storage medium storing instructions is provided. The instructions may be executed by at least one processor, cause the at least one processor to provide a plurality of Pareto fronts based on at least two performance parameters. The instructions may be executed by at least one processor, cause the at least one processor to identify an optimal Pareto front from among the plurality of Pareto fronts. The instructions may be executed by at least one processor, cause the at least one processor to provide a second AI model iteratively. The instructions may be executed by at least one processor, cause the at least one processor to identify whether the second AI model belongs to the optimal Pareto front. The instructions may be executed by at least one processor, cause the at least one processor to identify the at least two performance parameters with respect to the second AI model based on the identifying that the second AI model belongs to the optimal Pareto front. The instructions may be executed by at least one processor, cause the at least one processor to obtain the second AI model based on identifying that the second AI model meets one or more predetermined performance parameters.

### BRIEF DESCRIPTION OF FIGURES

The above and other aspects, features, and advantages of certain embodiments of the present disclosure will be more apparent from the following description taken in conjunction with the accompanying drawings, the above and other aspects, features, and advantages of certain embodiments of the present disclosure will be more apparent from the following description taken in conjunction with the accompanying drawings, in which:

FIG. 1 is a block diagram of an electronic device for providing a NAS, according to an embodiment;

FIG. 2A is a flow chart illustrating a process for providing the NAS by the electronic device according to an embodiment;

FIG. 2B is a flow chart illustrating example operations included in a method of achieving multi-objective optimization;

FIG. 3 is a flow chart illustrating a method for providing the NAS by the electronic device, according to an embodiment;

FIG. 4 is a graph illustrating an embodiment of objective function space of 2 dimensional according to the disclosure;

FIG. 5 is a graph illustrating an embodiment of objective function space of 2 dimensional according to the disclosure;

FIG. 6 is a flow chart illustrating a Likelihood Agnostic Metaheuristics approach for Pareto-optimization that facilitates swift and precise designing of DNNs, according to embodiments;

FIG. 7A is an example graph of representing the plurality of objective values according to an embodiment of the disclosure;

FIG. 7B is an example graph of Pareto front according to an embodiment of the disclosure;

FIG. 7C is an example graph of Pareto fronts according to an embodiment of the disclosure;

FIG. 8 is an example illustrating likelihood agnostic metaheuristics for Pareto-optimality for fast and accurate design of the DNNs, according to embodiments; and

FIG. 9 is a schematic diagram of classifier according to an embodiment of the disclosure.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings may be used to help easily understand various technical features, and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein relate to a method for performing a NAS in an electronic device. The method may include selecting, by the electronic device, a plurality of first AI models and evaluating at least two performance parameters of each of the first AI models. Further, the method may include generating, by the electronic device, a plurality of Pareto fronts based on the at least two performance parameters. Further, the method may include determining, by the electronic device, an optimal Pareto front from among the plurality of Pareto fronts. Further, the method may include generating, by the electronic device, a second AI model iteratively by checking whether the second AI model belongs to the optimal Pareto front. Further, the method may include evaluating, by the electronic device, at least two performance parameters of the second AI model based on determining that the second AI model belongs to the optimal Pareto front. Further, the method may include selecting, by the electronic device, the second AI model as an optimal model based on the second AI model meeting predetermined performance parameters.

Accordingly, embodiments may relate to an electronic device for providing the NAS. The electronic device may include a memory, a processor coupled to the memory and a communicator coupled to the memory and the processor. The electronic device may include a Pareto-optimality controller coupled to the memory, the processor and the communicator. In embodiments, the processor and the Pareto-optimality controller may be included in or implemented by a single processor or a plurality of processors, and may be referred to for example as at least one processor. The Pareto-optimality controller may be configured to select the plurality of first AI models and evaluate at least two performance parameters of each of the first AI models. Further, the Pareto-optimality controller may be configured to generate a plurality of Pareto fronts based on the at least two performance parameters of each of the first AI models. Further, the Pareto-optimality controller may be configured to determine the optimal Pareto front from among the plurality of Pareto fronts, and generate the second AI model iteratively. Further, the Pareto-optimality controller may be configured to check whether the second AI model belongs to the optimal Pareto front and evaluate at least two performance parameters of the second AI model based on determining that the second AI model belongs to the optimal Pareto front. Further, the Pareto-optimality controller may be configured to select the second AI model as the optimal model based on the second AI model meeting predetermined performance parameters.

Embodiments may relate to a novel Bayesian methodology for accomplishing multi-objective optimization. For example, embodiments may entail the selection of a multitude of initial AI models, and the subsequent evaluation of each model based on various performance parameters such as accuracy, inference time, and size.

In an embodiment, the AI model may include the first AI model or the second AI model.

In an embodiment, the first AI model may include the initial AI model.

In an embodiment, the plurality of objectives may be dependent on the plurality of variables.

In an embodiment, the objective may determine the performance parameter.

In an embodiment, the performance parameter may be determined based on the objective.

Moreover, embodiments may generate a plurality of Pareto fronts derived from the performance parameters of each initial AI model, from which the optimal Pareto front is identified. Further embodiments may iteratively generate a second AI model and examine its placement on the optimal Pareto front. The performance parameters of the second AI model may also be assessed and only selected as an optimal model when they satisfy predetermined performance parameters, ultimately leading to swift and precise designs.

Referring now to the drawings, in which similar reference characters denote corresponding features consistently throughout the figures, embodiments are described below.

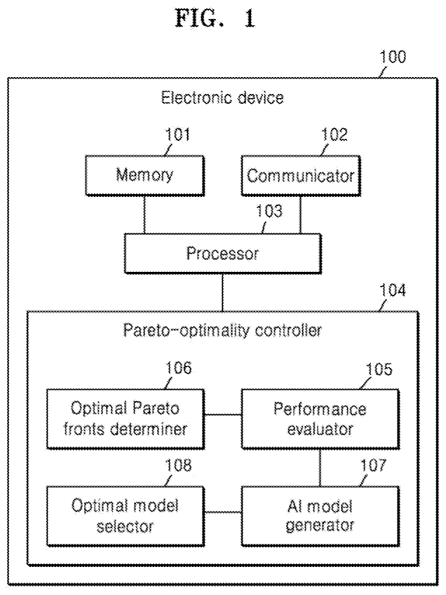

FIG. 1 is a block diagram of an electronic device (100) for providing a NAS, according to an embodiment as disclosed herein.

The electronic device (100) may include a memory (101), a processor (103), a communicator (102), and a Pareto-optimality controller (104). As discussed above, in some embodiments, the processor (103) and the Pareto-optimality controller (104) may be included in or implemented by a single processor or a plurality of processors, and may be referred to for example as at least one processor. In some embodiments, the Pareto-optimality controller (104) may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be included in one or more semiconductors.

The memory (101) may be configured to store instructions to be executed by the processor (103). The memory (101) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) can be configured to store larger amounts of information. In certain examples, a non-transitory storage medium may store data that can, over time, change (e.g., in Random Access Memory (RAM) or cache).

The processor (103) may communicate with the memory (101), the communicator (102) and the Pareto-optimality controller (104). The processor (103) may be configured to execute instructions stored in the memory (101) and to perform various processes. The processor may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (102) may include an electronic circuit specific to a standard that enables wired or wireless communication. The communicator (102) may be configured to communicate internally between internal hardware components of the electronic device (100) and with external devices via one or more networks.

The Pareto-optimality controller (104) may include a performance evaluator (105), an optimal Pareto fronts determiner (106), an AI model generator (107), and an optimal model selector (108).

The performance evaluator (105) may select a plurality of first AI models and evaluate at least two performance parameters of each of the first AI models.

The optimal Pareto fronts determiner (106) may generate a plurality of Pareto fronts based on the at least two performance parameters of each of the first AI models and determine an optimal Pareto front from among the plurality of Pareto fronts.

The AI model generator (107) may generate a second AI model iteratively.

The performance evaluator (105) may check whether the second AI model belongs to the optimal Pareto front and evaluates at least two performance parameters of the second AI model when the second AI model belongs to the optimal Pareto front.

The optimal model selector (108) may select the second AI model as an optimal model based on determining that the second AI model meets predetermined performance parameters.

In an embodiment, the plurality of first AI models may be or may include at least one of a set of random AI model and a set of predetermined AI designs.

In an embodiment, the Pareto front may include AI models which are equally significant with respect to a plurality of objectives.

In an embodiment, the optimal Pareto front may be a dominating Pareto front from among the plurality of Pareto fronts with respect to a plurality of objectives. For example, the optimal Pareto front may dominate all of the plurality of Pareto fronts with respect the plurality of objectives, and may not be dominated by any of the plurality of Pareto fronts with respect to the plurality of objectives.

In an embodiment, a classifier may be used to check belongingness of the second AI model to the optimal Pareto front.

In an embodiment, the classifier may be a binary classifier.

For example, the classifier may be at least one of MLP, XGB, Decision trees or SVM.

In one embodiment, the Pareto-optimality controller (104) may include a multitude of modules/components, with at least one of them being executed via an AI model. The AI model's function may be executed through the memory (101) and processor (103) components. These processors may be responsible for managing the input data processing according to predetermined operational guidelines or the AI model stored in both non-volatile and volatile memory. The set operational guidelines or the AI model may be acquired through a process of training or learning.

Although the FIG. 1 shows various hardware components of the electronic device (100) but embodiments are not limited thereto. In an embodiment, the electronic device (100) may include less or more number of components. Further, the labels or names of the components are used only for illustrative purpose and does not limit the scope of the disclosure. One or more components can be combined together to perform same or substantially similar function in the electronic device (100).

Embodiments may relate to the provision of a learning-based approach whereby a set of learning data is subjected to a learning process for the development of a predetermined operational principle or artificial intelligence (AI) model possessing a desired attribute. This learning modality may be executed within the confines of the AI-enabled device itself, as per an illustrative embodiment, or could be executed externally, on a dedicated server or system.

The AI model may include multiple neural network layers, each layer characterized by a multitude of weight values. The layer operation may be executed via computation of a previous layer alongside a range of weights. The AI model may include neural network types such as convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks, among others.

The process of learning may include training a pre-selected target device, such as a robot, through a multitude of learning data. The objective may be to enable or regulate the device's ability to make decisions or predictions. Various forms of learning processes may be used, including but not restricted to supervised, unsupervised, semi-supervised, and reinforcement learning.

Embodiments may be referred to as Likelihood Agnostic Metaheuristics for Pareto-optimality (LAMP), which may include a range of functionalities, such as multi-objective Bayesian optimization and personalized AI. By employing a multi-objective optimization strategy, LAMP may simultaneously may maximize both accuracy and on-device performance KPIs, including but not limited to higher predictability, lower memory latency, and power consumption. The Bayesian approach may employ a classifier as a surrogate, enabling efficient strategies and faster neural architecture search, ultimately improving time to market. Personalized AI may further facilitate faster optimization, empowering on-device NAS to construct performance-efficient AI models tailored to specific users. Embodiments may encompass sorting into Pareto, learning to classify, predicting likelihood, acquiring the best, and refining prior, among others.

Embodiments may provide one or more of the following advantage compared with some other systems and methods:
1. Improved search time (e.g. 10 times).
2. Improved latency (e.g. 12.5%) and accuracy (e.g. 43%) for AINR model.
3. Designs of AI models (e.g. 6 designs) according to embodiments may perform better than some other models for AINR in Expert Raw use-case.
4. Increased emphasis on model accuracy, on-device performance and scope for personalization.

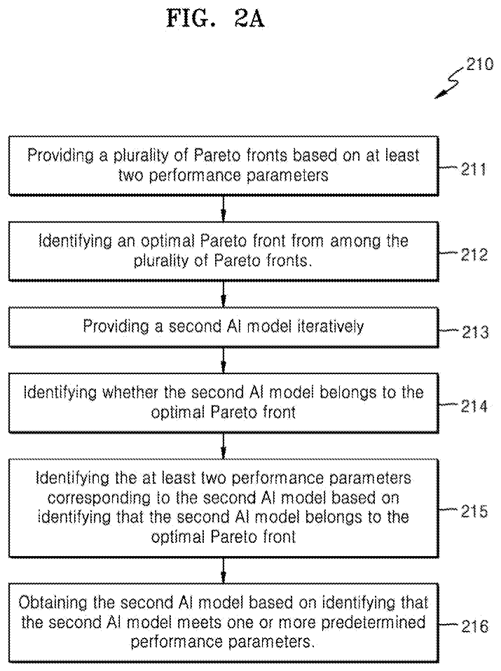

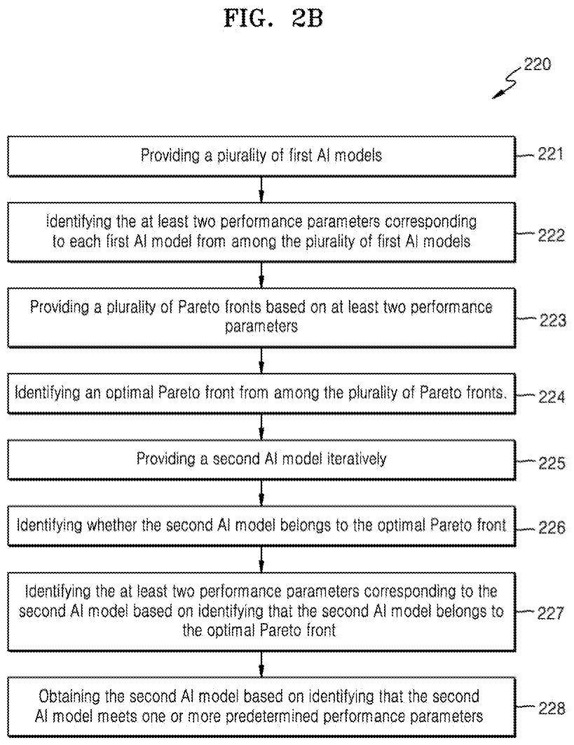

FIG. 2A is a flow chart illustrating a process (210) for providing the NAS by the electronic device (100), according to an embodiment as disclosed herein. The Pareto-optimality controller (104) may be configured to perform the operations 211 to 215.

As shown in FIG. 2A, the electronic device (100) may proceed to provide a plurality of Pareto fronts based on at least two performance parameters. A plurality of Pareto fronts may be generated in operation 211. The plurality of Pareto fronts may be provided in operation 211. Next, at operation 212, the electronic device (100) may determine the optimal Pareto front among the plurality of Pareto fronts. The electronic device (100) may identify an optimal Pareto front from among the plurality of Pareto fronts. At operation 213, the second AI model may be generated iteratively. The electronic device (100) may provide a second AI model iteratively. The electronic device (100) may continuously check whether the second AI model belongs to the optimal Pareto front at operation 214. The electronic device (100) may determine whether the second AI model belongs to the optimal Pareto front. The electronic device (100) may identify whether the second AI model belongs to the optimal Pareto front. The electronic device (100) may identify that the second AI model belongs to the optimal Pareto front. The electronic device (100) may evaluate at least two performance parameters of the second AI model based on determining that the second AI model belongs to the optimal Pareto front at operation 215. The electronic device (100) may identify at least two performance parameters of the second AI model based on the identifying whether the second AI model belongs to the optimal Pareto front at operation 215. Based on determining that the second AI model meets predetermined performance parameters, the electronic device (100) may select the second AI model as the optimal model at operation 216. The electronic device (100) may obtain the second AI model based on identifying that the second AI model meets one or more predetermined performance parameters. The electronic device (100) may obtain the second AI model that belongs to the optimal Pareto front. The second AI model may be obtained by identifying that the second AI model belongs to the optimal Pareto front.

FIG. 2B is a flow chart illustrating a process (220) for providing the NAS by the electronic device (100), according to an embodiment as disclosed herein. The Pareto-optimality controller (104) may be configured to perform the operations 221 to 228.

As shown in FIG. 2B, the electronic device (100) may proceed to select a plurality of first AI models at operation 221. The electronic device (100) may provide the plurality of first AI models at operation 221. At operation 222, the electronic device (100) may evaluate at least two performance parameters of each first AI model. The electronic device (100) may identify the at least two performance parameters of each first AI model from among the plurality of first AI models. Based on these evaluations, a plurality of Pareto fronts may be generated in operation 223. Next, at operation 224, the electronic device (100) may determine the optimal Pareto front among the plurality of Pareto fronts. The electronic device (100) may identify an optimal Pareto front from among the plurality of Pareto fronts. At operation 225, the second AI model may be generated iteratively. The electronic device (100) may provide a second AI model iteratively. The electronic device (100) may continuously check whether the second AI model belongs to the optimal Pareto front at operation 226. The electronic device (100) may determine whether the second AI model belongs to the optimal Pareto front. The electronic device (100) may identify whether the second AI model belongs to the optimal Pareto front. The electronic device (100) may evaluate at least two performance parameters of the second AI model based on determining that it does belong to the optimal Pareto front at operation 227. The electronic device (100) may identify at least two performance parameters of the second AI model based on identifying that the second AI model belongs to the optimal Pareto front at operation 227. Based on determining that the second AI model meets predetermined performance parameters, the electronic device (100) may select the second AI model as the optimal model at operation 228. The electronic device (100) may obtain the second AI model based on identifying that the second AI model meets one or more predetermined performance parameters.

Embodiments may possess a myriad of advantages in comparison to traditional methodologies and systems. These include but are not limited to swifter design, leading to an improved time to market, as well as improved server KPIs that encompass highly accurate models. Moreover, embodiments may provide enhanced on-device KPIs that include lightweight, fast, and energy-efficient models, thereby maximizing utility and scope. Additionally, this generic approach may have the capacity to enable on-device personalized NAS.

The various actions, acts, blocks, steps, or the like illustrated in FIG. 2 may be performed in the order presented, in a different order or simultaneously. Further, in some embodiments, some of the actions, acts, blocks, steps, or the like may be omitted, added, modified, skipped, or the like without departing from the scope of the invention.

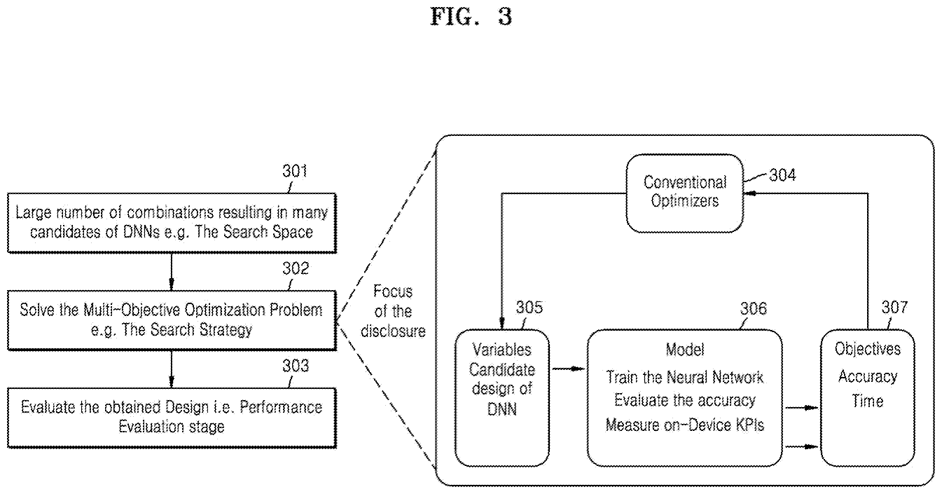

FIG. 3 is a flow chart illustrating steps involved in some methods for providing multi-objective optimization, according to a comparative example.

At operation 301, the electronic device may generate a vast array of combinations, resulting in a multitude of candidates for DNNs—e.g., the search space. Moving on to operation 302, the device then proceeds to tackle the multi-objective optimization problem—e.g., the search strategy—which involves a systematic repetition of loops leading to several function calls. Operation 303 may include evaluating the resulting design—e.g., a performance evaluation stage. At operation 304, the comparative example optimizer may generate variables for candidate designs of DNN, which may be further refined at operation 305. Operation 306 may encompass a wide range of activities, including training the neural network, evaluating its accuracy, and measuring on-device KPIs. Finally, at operation 307, the model's objectives may be centered around accuracy and time.

In comparative example NAS method and system of FIG. 3, the computational expenses for a single function call may be a relatively large amount of time, approximately 5 days, making it a time-consuming process to train a single candidate network. Therefore, there is a need for a technique that minimizes function calls in NAS.

Methods and systems according to the comparative example discussed above may typically devise a network design process that considers one or more objectives in a sequential manner. However, embodiments of the present disclosure may differ from the comparative example by concurrently taking into account all the objectives for the optimal design of networks.

Methods and systems according to the comparative example discussed above may fail to operate efficiently on the Pareto optimal set of candidates, whereas embodiments of the present disclosure may operate seamlessly on Pareto fronts. Unlike the comparative example discussed above, embodiments of the present disclosure may introduce a classifier as a surrogate model, and may adopt a Bayesian approach to expedite the Neural Architecture Search process. Moreover, embodiments of the present disclosure may advance the development of on-device personalized AI models, which stands out from the comparative example discussed above.

Methods and systems according to the comparative example may scour through a multitude of networks to find suitable architectures. In contrast, embodiments of the present disclosure may relate to a methodology for AI model design, and also divert from the process of searching through pre-existing structures.

Methods and systems according to the comparative example discussed above may rely on a single performance metric, resulting in a solitary objective optimization problem. In contrast, embodiments of the present disclosure may prioritize multi-objective optimization, taking into account all performance objectives simultaneously. Unlike the comparative example, embodiments may aim to enhance AI model search and design. Furthermore, the embodiments of the present disclosure may employ a Bayesian technique to pinpoint the optimal AI model design. The benefits of this method and system may extend beyond the comparative example, and may include higher accuracies, reduced on-device inference time, and a smaller search space, with 4 million candidate AI models (DNN) as an example.

Network designs according to the comparative example may typically prioritize minimizing parameters and maximizing accuracy, with little emphasis placed on on-device performance. In contrast, embodiments of the present disclosure may accuracy as a key objective while also factoring in on-device performance metrics such as latency, memory accuracy, data, and power consumption.

In contrast with the comparative example discussed above, embodiments may relate to a novel Bayesian methodology for accomplishing multi-objective optimization. For example, embodiments may entail the selection of a plurality of (e.g., a multitude of) initial AI models (e.g., the first AI models), and the subsequent evaluation of each model based on various performance parameters such as accuracy, inference time, and size.

Moreover, embodiments may generate a plurality of Pareto fronts derived from the performance parameters of each initial AI model (e.g., the first AI model), from which the optimal Pareto front may be identified. In addition, embodiments may iteratively generate a second AI model and examine its placement on the optimal Pareto front. The performance parameters of the second AI model may also be assessed and only selected as an optimal model when they satisfy predetermined performance parameters, ultimately leading to swift and precise designs.

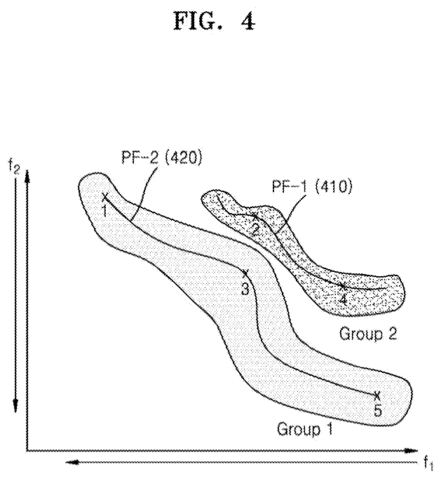

FIG. 4 is a graph illustrating an embodiment of objective function space of 2 dimensional according to the disclosure.

In an embodiment, the AI network for noise reduction (AINR) network may be a U-Net based network with 80 layers. As an example, among 80 layers, 22 layers may have an activation function called PReLU. For example, the objectives are to minimize the time consumed by this network to perform noise reduction and maximize the accuracy of AINR. For example, PReLU may be slow on GS23 hardware while another variant ReLU may be extremely fast. But ReLU may reduce the accuracy of the AINR network. For example, among 22 variables that each can be either ReLU or PReLU may be determined to maximize accuracy of AINR and minimize the time. In this example, the problem size is 222, has 4 million alternatives. AINR may be one in several relevant use-cases where NAS boils down to multi-objective computationally expensive optimization.

An embodiment of this disclosure has 5 candidate networks of AINR for example. The five candidates can be represented in binary vectors of size 22:

Example Candidate: 0-0-1-1-1-1-1-1-1-1-1-1-1-1-0-1-1-0-0-1-1-1.

Here 0 stands for PReLU activation in the given layer and 1 stands for ReLU for example. Based on NAS, two objectives may be set as follows:

$${f}_{1} = Number of PReLUs$$

Minimize f₁ to minimize the time of the network.

$${f}_{2} = Loss after training the network$$

Minimize f₂ to maximize the accuracy of the network.

After evaluating of objectives, the candidate networks can be plotted as shown in FIG. 4. The embodiment divides the 5 candidates into two groups. For example, dividing the candidates into groups may be based on the performance parameters. In an embodiment, the first AI model may include the candidate in the embodiment. For example, dividing the candidates into a plurality of groups may include providing a plurality of Pareto Fronts. Group 1 is PF-2 420, those which constitute the best front (e.g., the optimal front). Group 2 is PF-1 410, those which constitute all other front.

In an embodiment, not all candidates may be equally significant and there are two Pareto fronts: PF-1 410 and PF-2 420, where PF-2 420 is better front than PF-1 410. In an embodiment, the optimal Pareto front comprises a plurality of candidates (e.g., AI models, the first AI models or the second AI models) which are equally significant with respect to a plurality of objectives. In an embodiment, PF-3 which will be better than PF-2 420 can be provided, now the optimal front may be PF-3. However, embodiments are not limited thereto.

In an embodiment, a classifier may divide the candidates into a plurality of groups. For example, the classifier may be used to determine whether the AI model (e.g., AI model, the first AI model or the second AI model) belongs to the optimal Pareto front. The classifier may calculate a probability that candidate belongs to one of the plurality of groups. The classifier may be used to identify the candidate belongs to the optimal Pareto front. The classifier may be trained to distinguish the candidates into the plurality of groups. In an embodiment, the classifier may be a binary classifier (e.g., MLP, XGB, Decision trees, SVM, etc.). In an embodiment, the binary classifier (e.g., MLP, XGB, Decision trees, SVM, etc.) may be fitted to distinguish candidates belonging to Group 1 (e.g., PF-2 420) from those in Group 2 (e.g., PF-1 410).

In an embodiment, a new candidate (e.g., the second AI model) may be designated as Candidate 6 if it maximally belongs to Group 1 (e.g., PF-2 420). In an embodiment, candidate 6 is the vector that maximizes the probability that candidate belongs to Group 1. It may be a single objective optimization problem that can be solved using gradient descent (off-the-shelf algorithm) according to the embodiment. Once Candidate 6 is obtained, f₁ and f₂ (e.g., the performance parameters) can be evaluated to truly identify whether it belongs to Group 1 or Group 2. In an embodiment, a second AI model is provided by identifying whether the second AI model belongs to the optimal Pareto front. In an embodiment, now 6 candidates were plotted, and repeat the process to find Candidate 7. Thus, the second AI model (e.g., the new candidate) is provided iteratively by determining whether the second AI model belongs to the optimal Pareto front.

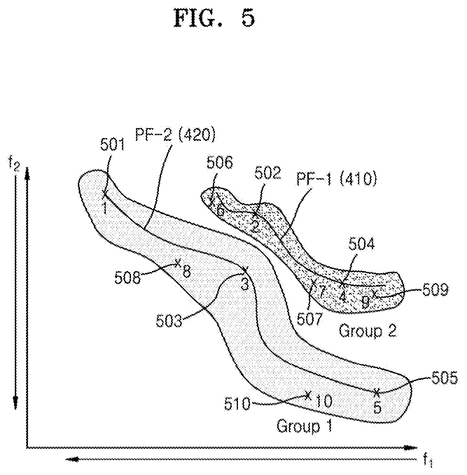

FIG. 5 is a graph illustrating an embodiment of objective function space of 2 dimensional according to the disclosure.

In evolutionary optimization algorithms according to the comparative example, the plurality of performance parameters (e.g., f₁ or f₂) are evaluated first to identify the new candidate. For example, using X₁ 501 to X₅ 505, 5 AINR candidates, evolutionary algorithms (EA) generate 5 more AINR candidates in one step: X₆^{EA} 506 to X₁₀^{EA} 510. All five candidates are trained and only X₈^{EA} 508 and X₁₀^{EA} 510 are found to be better. The evaluations on X₆^{EA}, X₇^{EA}, and X₉^{EA} are wasted. These shouldn't have been considered in the first place.

In Likelihood Agnostic Metaheuristics for Pareto-optimality (LAMP) according to an embodiment of the disclosure, the best candidate (e.g., the second AI model) may be found and designated as X₆^{LAMP} first and only then the expensive f₁ and f₂ (e.g., the performance parameters) may be evaluated. And even if it fails (e.g., with least probability), this wouldn't have wasted 4 function calls like EA.

In an embodiment, the optimal Pareto front may be identified. In an embodiment, the recipe of LAMP may follow the Bayesian philosophy: forming the belief that Group 1 (PF-2 420) is the best (e.g., the optimal), sampling an evidence in form of a new candidate (e.g., the second AI model), and modifying the belief about Group 1 420 (or Group 2 410). Keep repeating this till eventually the belief is modified to reality. In an embodiment, evaluating the at least two performance parameters with respect to the second AI model based on determining that the second AI model belongs to the optimal pareto front.

In an embodiment, obtaining the second AI model based on determining that the second AI model meets one or more predetermined performance parameters. In conventional Bayesian models, the new candidate may be obtained by truly measuring its ability to improve the optimality—also known as likelihood. This may restrict the usage to single objective optimization and to very low-dimensional decision space (e.g., less than 10 dimensions). By making it likelihood-agnostic, likelihood-agnostic may remove the restrictions on decision space, for example, likelihood-agnostic may enable fast and accurate NAS of deep neural networks.

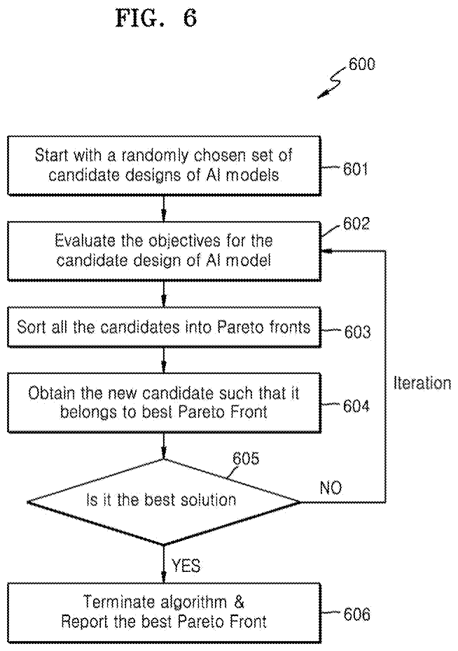

FIG. 6 is a flow diagram illustrating an example of the LAMP for fast and accurate design of DNNs, according to the embodiments herein.

In reference to FIG. 6, the electronic device (100) may begin the process (600) at operation 601 by selecting a set of candidate designs for AI models (e.g., the first AI models), either at random or from a pre-defined pool. In an embodiment, the plurality of first AI models may be provided. In an embodiment, the initial guess of candidates (e.g., the first AI models) could be random or set of pre-determined AI designs. The performance objectives for these candidates may be evaluated at operation 602. In an embodiment, the at least two performance parameters corresponding to each first AI model from among the plurality of first AI models may be identified. Next, at operation 603, the electronic device may sort the candidates into Pareto fronts. At operation 604, a new candidate may be selected from the best Pareto front. operation 605 may include determining whether this new candidate is the optimal solution. If so, the process (600) may terminate, and the electronic device (200) may report the best Pareto front at operation 606. Otherwise, the iteration count may be incremented by 1.

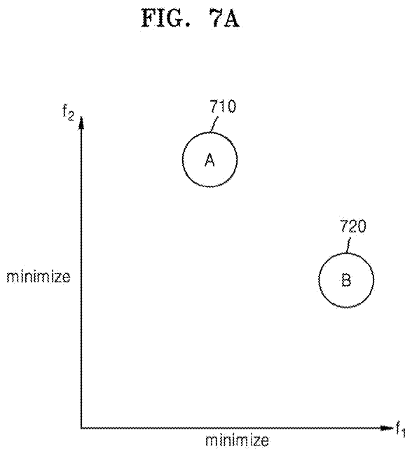

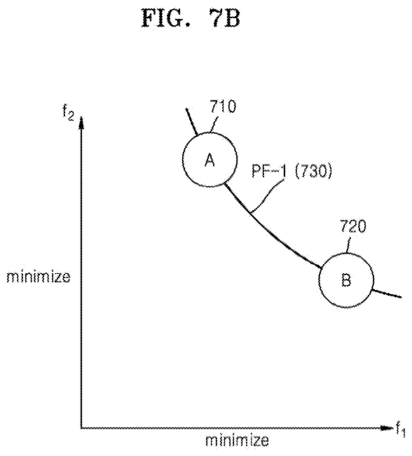

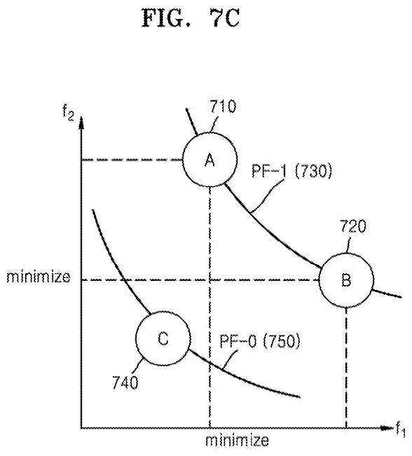

FIG. 7A is an example graph of representing the plurality of objective values according to an embodiment of the disclosure.

In an embodiment, the Pareto front may be or may refer to a collection of candidates (e.g., AI models, the first AI models or the second AI models) that hold equal importance across multiple objectives. As an illustration, consider candidate A 710 and candidate B 720, each with two objective values, f₁A and f₂A, and f₁B and f₂B, respectively. Here, f₁ may denote training loss and f₂ may denote on-device latency.

FIG. 7B is an example graph of Pareto front according to an embodiment of the disclosure.

In an embodiment, if candidate A 710 outperforms candidate B 720 with respect to one objective, and candidate B 720 outperforms candidate A 710 with respect to another objective, then both candidate A 710 and candidate B 720 may fall on the same front, for example Pareto Front PF-1 730.

FIG. 7C is an example graph of Pareto fronts according to an embodiment of the disclosure.

In an embodiment, if a third candidate C 740 outperforms A 710 and B 720 with respect to both objectives, candidate C 740 may belong to a new Pareto Front PF-0 750, which may be superior to Pareto Front PF-1 730. The goal may then be to identify a new candidate that belongs to Pareto Front PF-0 750 and not Pareto Front PF-1 730.

In one embodiment, the challenge presented at operation 601 may pertain to a specific training challenge. Particularly, the challenge may involve determining initial candidates that will dictate the course of the method and lead to the acquisition of high-quality initial candidates.

In an embodiment, the challenge at operation 602 may pertain to a computationally demanding training challenge. Specifically, the challenge may involve minimizing the overall evaluation time, which can be quite extensive.

In an embodiment, the challenge presented at operation 604 may pertain to device-specific implementation, specifically in determining whether the new candidate belongs to the optimal Pareto Front without conducting a full evaluation. Similarly, in an embodiment, the challenge at operation 606 may also be related to device implementation, particularly in determining when to terminate the method. An obstacle may lie in successfully implementing the on-device NAS.

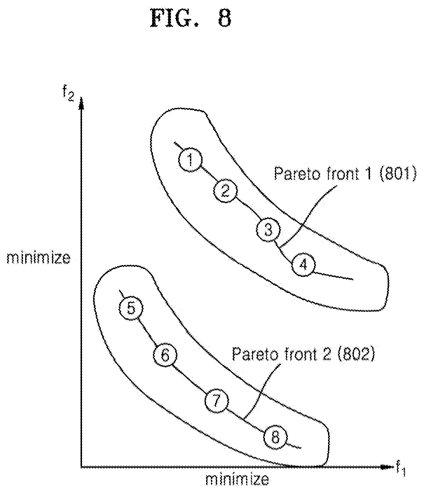

FIG. 8 is an example illustrating the likelihood agnostic metaheuristics for Pareto-optimality for fast and accurate design of DNNs, according to the embodiments herein.

Referring to FIG. 8, below points may be considered at a given iteration,
1. N Candidate designs may be evaluated for objectives (e.g., based on the performance parameters).
2. Sorted into Pareto Front 1 (801) and Pareto Front 2 (802).
3. Now the challenge may be to obtain Candidate N+1.
a. Without evaluating it for expensive objectives to enable faster search
b. Ensuring that Candidate N+1 is better than existing candidate to make sure that method works.
4. Use of existing N candidates to obtain the N+1:

Consider the example shown in Table 1, in which N=8

TABLE 1

| AI Designs | Label |
|---|---|
| Candidate 1 | 1 |
| Candidate 2 | 1 |
| Candidate 3 | 1 |
| Candidate 4 | 1 |
| Candidate 5 | 2 |
| Candidate 6 | 2 |
| Candidate 7 | 2 |
| Candidate 8 | 2 |

Label 2 indicates that candidate AI design belongs to Pareto Front (802), Label 1 indicates that candidate AI design belongs to Pareto Front (801).

Further, this data may be used to build a classifier that quickly learns to predict probability that a given design belongs to a Pareto Front as provided in Table 2 as an example.

TABLE 2

| | Probability that | Probability that |
|---|---|---|
| | Design belongs to | Design belongs to |
| AI Designs | Pareto Front 802 | Pareto Front 801 |
| Candidate 1 | 0.13 | 0.87 |
| . . . | . . . | . . . |
| Candidate 8 | 0.74 | 0.26 |

At a given iteration:
1. N Candidate designs may be evaluated for objectives (e.g., based on the performance parameters).
2. Sorted into Pareto Front 1 (801) and Pareto Front 2 (802).
3. Now the challenge is to obtain Candidate N+1.
a. Without evaluating it for expensive objectives.
b. Ensuring that Candidate N+1 is better than existing.
4. The proposed system may make use of existing N candidates to obtain the N+1 candidate:
Build a classifier to predict the belongingness of any given candidate design to Pareto Front 2 (802).
5. Search for the Candidate Design that has maximum P. The design with maximum P may be Candidate N+1.

By selecting the optimal candidate in the current iteration without actual evaluation, the classifier may acquire the capacity to perform AI design. In this manner, it may serve as a surrogate to the computationally demanding process. The present disclosure proposes a resolution to the challenge of implementing on-device solutions with multiple objectives, including Pareto Optimality, by prioritizing on-device performance and accuracy.

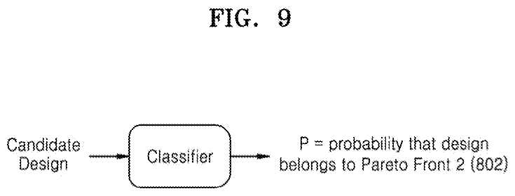

FIG. 9 is a schematic diagram of classifier according to an embodiment of the disclosure.

Referring to FIG. 9, the classifier may predict the probability that the candidate design belongs to the Pareto front. In an embodiment, the classifier may identify the probability that the candidate design belongs to the Pareto front. In an embodiment, the classifier may be used to identify whether the AI model belongs to the optimal Pareto front.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

According to an embodiment of the disclosure, a method may include providing, by the electronic device, a plurality of Pareto fronts based on at least two performance parameters. The method may include identifying, by the electronic device, an optimal Pareto front from among the plurality of Pareto fronts. The method may include providing, by the electronic device, a second AI model iteratively by identifying whether the second AI model belongs to the optimal Pareto front. The method may include identifying, by the electronic device, the at least two performance parameters corresponding to the second AI model based on identifying that the second AI model belongs to the optimal Pareto front. The method may include obtaining, by the electronic device, the second AI model based on identifying that the second AI model meets one or more predetermined performance parameters.

According to an embodiment of the disclosure, an electronic device comprising a memory, a communicator coupled to the memory and at least one processor coupled to the memory and the communicator is provided. The at least one processor may be configured to provide a plurality of Pareto fronts based on the at least two performance parameters. The at least one processor may be configured to identify an optimal Pareto front from among the plurality of Pareto fronts. The at least one processor may be configured to provide a second AI model iteratively. The at least one processor may be configured to identify whether the second AI model belongs to the optimal Pareto front. The at least one processor may be configured to identify the at least two performance parameters with respect to the second AI model based on identifying that the second AI model belongs to the optimal Pareto front. The at least one processor may be configured to obtain the second AI model based on identifying that the second AI model meets one or more predetermined performance parameters.

According to an embodiment of the disclosure, a non-transitory computer-readable storage medium storing instructions is provided. The instructions may be executed by at least one processor, cause the at least one processor to provide a plurality of Pareto fronts based on the at least two performance parameters. The instructions may be executed by at least one processor, cause the at least one processor to identify an optimal Pareto front from among the plurality of Pareto fronts. The instructions may be executed by at least one processor, cause the at least one processor to provide a second AI model iteratively. The instructions may be executed by at least one processor, cause the at least one processor to identify whether the second AI model belongs to the optimal Pareto front. The instructions may be executed by at least one processor, cause the at least one processor to identify the at least two performance parameters with respect to the second AI model based on identifying that the second AI model belongs to the optimal Pareto front. The instructions may be executed by at least one processor, cause the at least one processor to obtain the second AI model based on identifying that the second AI model meets one or more predetermined performance parameters.

According to an embodiment of the disclosure, a method may include generating, by the electronic device, a plurality of Pareto fronts based on at least two performance parameters. The method may include determining, by the electronic device, an optimal Pareto front from among the plurality of Pareto fronts. The method may include generating, by the electronic device, a second AI model iteratively by determining whether the second AI model belongs to the optimal Pareto front. The method may include evaluating, by the electronic device, the at least two performance parameters corresponding to the second AI model based on determining that the second AI model belongs to the optimal Pareto front. The method may include selecting, by the electronic device, the second AI model based on determining that the second AI model meets one or more predetermined performance parameters.

According to an embodiment of the disclosure, a method may include providing, by the electronic device, a plurality of first AI models. The method may include identifying, by the electronic device, the at least two performance parameters corresponding to each first AI model from among the plurality of first AI models.

According to an embodiment of the disclosure, a method may include selecting, by the electronic device, a plurality of first AI models. The method may include evaluating, by the electronic device, the at least two performance parameters corresponding to each first AI model from among the plurality of first AI models.

According to an embodiment of the disclosure, the plurality of first AI models may comprise at least one of a random AI model and a set of predetermined AI designs.

According to an embodiment of the disclosure, the optimal Pareto front may dominate the plurality of Pareto fronts with respect to a plurality of objectives.

According to an embodiment of the disclosure, a classifier may be used to identify whether the second AI model belongs to the optimal Pareto front.

According to an embodiment of the disclosure, the method may include using a classifier.

According to an embodiment of the disclosure, the at least two performance parameters may be determined based on a plurality of objectives.

According to an embodiment of the disclosure, the classifier may be a binary classifier.

According to an embodiment of the disclosure, the classifier may identify the optimal Pareto front by identifying each probability that second AI models belongs to the plurality of Pareto front.

According to an embodiment of the disclosure, an electronic device comprising a memory, a communicator coupled to the memory and at least one processor coupled to the memory and the communicator is provided. The at least one processor may be configured to generate a plurality of Pareto fronts based on the at least two performance parameters. The at least one processor may be configured to determine an optimal Pareto front from among the plurality of Pareto fronts. The at least one processor may be configured to generate a second AI model iteratively. The at least one processor may be configured to evaluate whether the second AI model belongs to the optimal Pareto front. The at least one processor may be configured to evaluate the at least two performance parameters with respect to the second AI model based on determining that the second AI model belongs to the optimal Pareto front. The at least one processor may be configured to select the second AI model based on identifying that the second AI model meets one or more predetermined performance parameters.

According to an embodiment of the disclosure, an electronic device comprising a memory, a communicator coupled to the memory and at least one processor coupled to the memory and the communicator is provided. The at least one processor may be configured to provide a plurality of first AI models. The at least one processor may be configured to identify the at least two performance parameters of each first AI model from among the plurality of first AI models.

According to an embodiment of the disclosure, an electronic device comprising a memory, a communicator coupled to the memory and at least one processor coupled to the memory and the communicator is provided. The at least one processor may be configured to select a plurality of first AI models. The at least one processor may be configured to evaluate the at least two performance parameters of each first AI model from among the plurality of first AI models.

According to an embodiment of the disclosure, a non-transitory computer-readable storage medium storing instructions is provided. The instructions may be executed by at least one processor, cause the at least one processor to generate a plurality of Pareto fronts based on the at least two performance parameters. The instructions may be executed by at least one processor, cause the at least one processor to determine an optimal Pareto front from among the plurality of Pareto fronts. The instructions may be executed by at least one processor, cause the at least one processor to generate a second AI model iteratively. The instructions may be executed by at least one processor, cause the at least one processor to determine whether the second AI model belongs to the optimal Pareto front. The instructions may be executed by at least one processor, cause the at least one processor to evaluate the at least two performance parameters with respect to the second AI model based on determining that the second AI model belongs to the optimal Pareto front. The instructions may be executed by at least one processor, cause the at least one processor to select the second AI model based on determining that the second AI model meets one or more predetermined performance parameters.

According to an embodiment of the disclosure, a non-transitory computer-readable storage medium storing instructions is provided. The instructions may be executed by at least one processor, cause the at least one processor to provide a plurality of first AI models. The instructions may be executed by at least one processor, cause the at least one processor to identify the at least two performance parameters of each first AI model from among the plurality of first AI models.

According to an embodiment of the disclosure, a non-transitory computer-readable storage medium storing instructions is provided. The instructions may be executed by at least one processor, cause the at least one processor to select a plurality of first AI models. The instructions may be executed by at least one processor, cause the at least one processor to evaluate the at least two performance parameters of each first AI model from among the plurality of first AI models.

1. A method for providing a neural architecture search (NAS) in an electronic device, wherein the method comprises:
providing, by the electronic device, a plurality of Pareto fronts based on at least two performance parameters;
identifying, by the electronic device, an optimal Pareto front from among the plurality of Pareto fronts;
providing, by the electronic device, a second AI model iteratively;
identifying, by the electronic device, whether the second AI model belongs to the optimal Pareto front;
identifying, by the electronic device, the at least two performance parameters corresponding to the second AI model based on identifying that the second AI model belongs to the optimal Pareto front; and
obtaining, by the electronic device, the second AI model based on identifying that the second AI model meets one or more predetermined performance parameters.

2. The method as claimed in claim 1, wherein before the providing the plurality of Pareto fronts based on the at least two performance parameters further comprises:
providing, by the electronic device, a plurality of first AI models; and
identifying, by the electronic device, the at least two performance parameters corresponding to each first AI model from among the plurality of first AI models.

3. The method as claimed in claim 2, wherein the plurality of first AI models comprises at least one of a random AI model or a set of predetermined AI designs.

4. The method as claimed in claim 1, wherein the optimal Pareto front comprises a plurality of AI models which are equally significant with respect to a plurality of objectives.

5. The method as claimed in claim 1, wherein the optimal Pareto front dominates the plurality of Pareto fronts with respect to a plurality of objectives.

6. The method as claimed in claim 1, wherein the identifying whether the second AI model belongs to the optimal Pareto front comprises using a classifier.

7. The method as claimed in claim 1, wherein the at least two performance parameters are determined based on a plurality of objectives.

8. The method as claimed in claim 6, wherein the classifier is a binary classifier.

9. The method as claimed in claim 6, wherein the classifier identifies the optimal Pareto front by identifying each probability that the second AI models belongs to the plurality of Pareto front.

10. An electronic device for providing a neural architecture search (NAS), wherein the electronic device comprises:
a memory;
a communicator coupled to the memory; and
at least one processor coupled to the memory and the communicator,
wherein the at least one processor is configured to:
provide a plurality of Pareto fronts based on at least two performance parameters;
identify an optimal Pareto front from among the plurality of Pareto fronts;
provide a second AI model iteratively;
identify whether the second AI model belongs to the optimal Pareto front;
identify the at least two performance parameters with respect to the second AI model based on identifying that the second AI model belongs to the optimal Pareto front; and
obtain the second AI model based on identifying that the second AI model meets one or more predetermined performance parameters.

11. The electronic device as claimed in claim 10, wherein the at least one processor is further configured to:
provide a plurality of first AI models; and
identify the at least two performance parameters of each first AI model from among the plurality of first AI models.

12. The electronic device as claimed in claim 11, wherein the plurality of first AI models comprises at least one of a random AI model and a set of predetermined AI designs.

13. The electronic device as claimed in claim 10, wherein the optimal Pareto front comprises a plurality of AI models which are equally significant with respect to a plurality of objectives.

14. The electronic device as claimed in claim 10, wherein the optimal Pareto front dominates the plurality of Pareto fronts with respect to a plurality of objectives.

15. The electronic device as claimed in claim 10, wherein the identifying whether the second AI model belongs to the optimal Pareto front comprises using a classifier.

16. The electronic device as claimed in claim 10, wherein the at least two performance parameters are determined based on a plurality of objectives.

17. The electronic device as claimed in claim 15, wherein the classifier is a binary classifier.

18. The electronic device as claimed in claim 15, wherein the classifier identifies the optimal Pareto front by identifying each probability that second AI models belongs to the plurality of Pareto front.

19. A non-transitory computer-readable storage medium storing instructions that, when executed by at least one processor, cause the at least one processor to:
provide a plurality of Pareto fronts based on at least two performance parameters;
identify an optimal Pareto front from among the plurality of Pareto fronts;
provide a second AI model iteratively;
identify whether the second AI model belongs to the optimal Pareto front;
identify the at least two performance parameters with respect to the second AI model based on identifying that the second AI model belongs to the optimal Pareto front; and
obtain the second AI model based on identifying that the second AI model meets one or more predetermined performance parameters.

20. The non-transitory computer-readable storage medium of claim 19, wherein the instructions, when executed by the at least one processor, further cause the at least one processor to:
provide a plurality of first AI models; and
identify the at least two performance parameters of each first AI model from among the plurality of first AI models.
